(19) United States
(12) Patent Application Publication
(10) Pub. No.: US 2025/0306174 A1
(43) Pub. Date: Oct. 2, 2025

(54) LiDAR and Autonomous Driving Apparatus

(71) Applicant: SUTENG INNOVATION TECHNOLOGY CO., LTD., Shenzhen (CN)

(72) Inventors: Kunyi Li, Shenzhen (CN); Shjia Yan, Shenzhen (CN); Yifei Wang, Shenzhen (CN)

(73) Assignee: SUTENG INNOVATION TECHNOLOGY CO., LTD., Shenzhen (CN)

(21) Appl. No.: 18/972,363

(22) Filed: Dec. 6, 2024

(30) Foreign Application Priority Data
Mar. 29, 2024 (CN) 202410383041.7

(51) Int. Cl. G01S 7/481

(52) U.S. Cl. CPC G01S 7/4811; G01S 7/4815; G01S 7/4817

(57) ABSTRACT

Embodiments of the present application provide a laser ranging method, apparatus and LiDAR, the method comprising: obtaining a quantity of light-leading point cloud points in a first preset region in a current frame point cloud; wherein the light-leading point cloud points are point cloud points corresponding to echoes received by a receiver in a light-leading period, and the light-leading period is a period less than a first preset time length from the emission moment of a laser beam corresponding to the light-leading point cloud points; when the quantity of the light-leading point cloud points meets a first preset condition, adjusting the gain of the receiver in the light-leading period to reduce the quantity of the light-leading point cloud points.

### CROSS-REFERENCE TO RELATED APPLICATION

The present application claims the benefit of priority to Chinese Patent Application No. 202410383041.7, filed on Mar. 29, 2024, which is hereby incorporated by reference in its entirety.

### TECHNICAL FIELD

The present application relates to the field of light detection, and in particular to a LiDAR.

### BACKGROUND

LiDAR comprises an emitting system, a receiving system, and a data processing system. It measures distance by measuring the time difference between the emitted light and the received echo light. It has the advantages of high resolution, high sensitivity, strong anti-interference ability, and is not affected by lighting conditions. LiDAR has been widely used in autonomous driving, logistics vehicles, robots, vehicle-road collaboration, and public smart transportation.

### SUMMARY

Embodiments of the present application provides a LiDAR and autonomous driving apparatus that can use a simple system design to achieve large field of view and high-resolution detection.

In a first aspect, the present application provides a LiDAR, comprising: a transceiver module, a scanning module and a beam adjustment module;
the transceiver module is configured to emit outgoing light according to a preset timing, and emit the outgoing light toward the scanning module; the scanning module is configured to deflect the outgoing light toward the beam adjustment module;
the beam adjustment module is configured to increase an outgoing angle of the outgoing light, and the outgoing light is emitted toward a measured region at uniform angle intervals;
the beam adjustment module is configured to receive an echo light, and direct the echo light toward the scanning module;
the scanning module is configured to deflect the echo light toward the transceiver module; the transceiver module is configured to receive the echo light; wherein the echo light is a beam of light returned after the outgoing light is reflected by a measured object in the measured region.

In an embodiment, the LiDAR includes a mounting surface. The transceiver module, the scanning module and the beam adjustment module are arranged on the mounting surface, the transceiver module and the scanning module are arranged along a first direction, and the scanning module and the beam adjustment module are arranged along a second direction.

In an embodiment, the transceiver module includes an emitting component, a receiving component and a light splitting component; the emitting component is configured to emits the outgoing light, the receiving component is configured to receive the echo light, and the light splitting component is configured to separate the optical paths of the outgoing light and the echo light; wherein the emitting component and the receiving component are disposed on the mounting surface and arranged along the first direction.

In an embodiment, the emitting component includes a first emitter, a second emitter and an emitting mirror group, the first emitter and the second emitter are staggered in the first direction and the third direction, and are symmetrical along the central axis of the emitting mirror group, and the third direction is perpendicular to the first direction and the second direction.

In an embodiment, the first emitter and the second emitter are arranged on an emitting plate, the emitting plate is arranged along the first direction, and the emitting plate is rotated around the second direction by a first angle.

In an embodiment, the emitting component further includes a beam reducing mirror group, which is configured to reduce a cross-sectional size of the emitted light. A first output light emitted by the first emitter is emitted toward the beams reducing mirror group at a first incident angle, and the second output light emitted by the second emitter is emitted toward the beam reducing mirror group at a second incident angle, and the first incident angle and the second incident angle are opposite to each other.

In an embodiment, the beam reducing mirror group includes a dividing surface, a reflection region and a beam combining region arranged on sides of the dividing surface, the center axis of the first output light emitted to the beam reducing mirror group is spaced apart from the dividing surface by a first distance along the first direction, the center axis of the second output light is spaced apart from the dividing surface by a second distance along the first direction, and the first distance is equal to the second distance.

In an embodiment, a reflex component is further included, which is configured to deflect the outgoing light from the transceiver module to the scanning module, and deflect the echo light from the scanning apparatus to the transceiver module.

In an embodiment, the reflex component is arranged on the mounting surface, and the reflex component and the transceiver module are arranged along the second direction.

In a second aspect, the present application provides an autonomous driving apparatus, comprising an apparatus body and the LiDAR installed on the apparatus body.

In an embodiment of the present application, the LiDAR includes a transceiver module, a scanning module and a beam adjustment module. The transceiver module is configured to emit outgoing light according to a preset timing, and the outgoing light is directed to the scanning module; the scanning module is configured to deflect the received outgoing light so that the deflected outgoing light covers a certain angle range; the beam adjustment module is configured to increases the outgoing angle of the outgoing light from the scanning module; the outgoing light covers a larger angle range for outward detection. The echo light in the opposite direction of the outgoing light enters the transceiver module along the path of the beam adjustment module, the scanning module and the transceiver module, and the transceiver module receives the echo light to complete the detection. The LiDAR adopts a scanning module and a beam adjustment module to achieve a large field of view. The optical system architecture is simple in design.

### BRIEF DESCRIPTION OF DRAWINGS

FIG. 1 is a schematic diagram of the structure of a LiDAR provided in an embodiment of the present application.

FIG. 2 is a schematic diagram of the structure of a LiDAR provided in an embodiment of the present application.

FIG. 3 is a schematic diagram of the optical path of a LiDAR provided in an embodiment of the present application.

FIG. 4 is a side view of the emitting plate of the LiDAR provided in an embodiment of the present application along the second direction.

FIG. 5 is a schematic diagram of the optical path of the transceiver module of the LiDAR provided in an embodiment of the present application.

FIG. 6 is a schematic diagram of the structure of the autonomous driving apparatus provided in an embodiment of the present application.

### REFERENCE SIGNS

1: LiDAR;
11: transceiver module;
111: emitting component;
1111: first emitter;
1112: second emitter;
1113: emitting mirror group;
1114: beam reducing mirror group;
1115: first output light;
1116: second output light;
1117: emitting plate;
112: receiving component;
113: beam splitting component;
12: scanning module;
13: beam adjustment module;
131: first lens;
132: second lens;
14: housing;
141: mounting surface;
15: reflex assembly;
2: apparatus body.

### DETAILED DESCRIPTION

Embodiments of the application will be described below with reference to the accompanying drawings.

The singular forms of “a”, “said” and “the” used in embodiments of this application and the appended claims are intended to include plural forms unless the context clearly indicates other meanings. The term “and/or” used herein refers to and includes any or all possible combinations of one or more associated listed items.

The terms “first”, “second”, “third”, etc. may be used to describe various information, this information should not be limited to these terms. These terms are only used to distinguish the same type of information from each other. For example, the first information may also be referred to as the second information, and similarly, the second information may also be referred to as the first information. Thus, the features defined as “first” and “second” may explicitly or implicitly include one or more of the features. The meaning of “multiple” is two or more, unless otherwise clearly and defined.

The same or similar quantities in the drawings of this embodiment correspond to the same or similar parts; if the terms “upper”, “lower”, “left”, “right”, etc. indicate an orientation or position relationship based on the orientation or position relationship shown in the drawings, it is only for the convenience of describing this application and simplifying the description, rather than indicating or implying that the apparatus or element referred to must have a specific orientation, be constructed and operated in a specific orientation. Therefore, the terms describing the position relationship in the drawings are only used for illustrative purposes.

LiDAR is a radarsystem that emits laser beams to detect a position, speed and other characteristic quantities of a target object. Its working principle is to use a laser emitter to emit multiple beams of light in sequence. If the emitted light encounters an object, it is reflected, and the receiver receives the reflected echo light. LiDAR is configured to calculate the time difference between the time of receiving the reflected echo light and the time of emitting the emitted light, and the time difference is the flight time of the laser beam. LiDAR is configured to calculate the distance, direction, reflectivity and other parameters of the object that reflects the laser beam based on the flight time, thereby detecting the external environment.

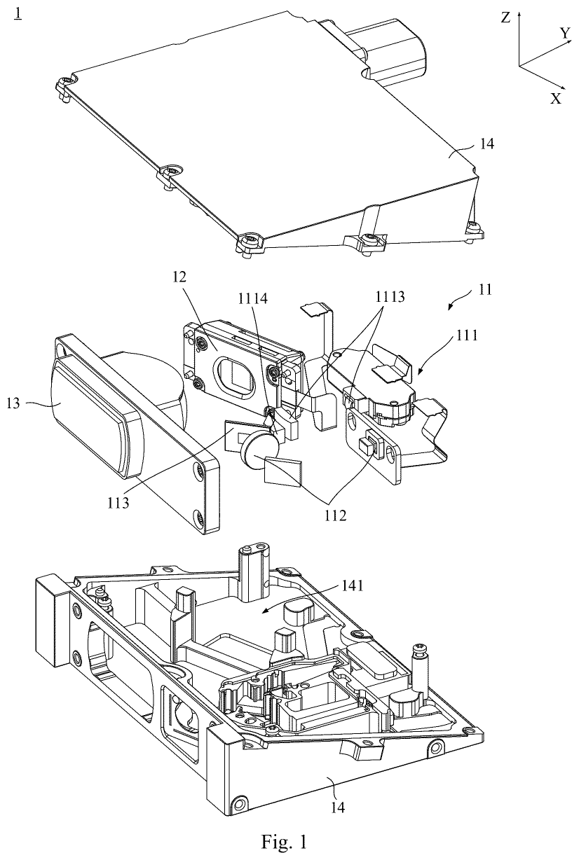

As shown in FIG. 1, FIG. 1 is a schematic diagram of an embodiment of a LiDAR 1, which include a transceiver module 11, a scanning module 12 and a beam adjustment module 13.

The transceiver module 11 is configured to emit an outgoing light according to a preset timing sequence, and emit it to the scanning module 12; the scanning module 12 is configured to deflect the outgoing light to the beam adjustment module 13; the beam adjustment module 13 is configured to increase the outgoing angle of the outgoing light, and the outgoing light is emitted to a measured region at a uniform angle interval. The beam adjustment module 13 is configured to receive the echo light and emits it to the scanning module 12; the scanning module 12 is configured to deflect the echo light to the transceiver module 11; the transceiver module 11 is configured to receive the echo light. The echo light is the beam returned by the outgoing light after being reflected by the measured object in the measured region.

The transceiver module 11 is configured to emit outgoing light and receive echo light. The transceiver module 11 is configured to emit an outgoing light according to a preset timing, and the outgoing light is directed to the scanning module 12; the scanning module 12 is configured to perform continuous motion, such as the galvanometer performs reciprocating motion, the rotating mirror performs continuous rotation, etc. The continuously moving scanning module deflects the received outgoing light, so that the outgoing light covers a certain angle range. The outgoing light deflected by the scanning module 12 can be directed to the beam adjustment module 13, and the beam adjustment module 13 is configured to increase the outgoing angle of the outgoing light from the scanning module 12, so that the outgoing light is directed to the measured region at a large outgoing angle, covering a larger angle range, and realizing large field angle detection. Meanwhile, the echo light in the opposite direction to the outgoing light enters the transceiver module 11 along the coaxial path of the beam adjustment module 13, the scanning module 12 and the transceiver module 11, and the transceiver module 11 receives the echo light to complete the detection.

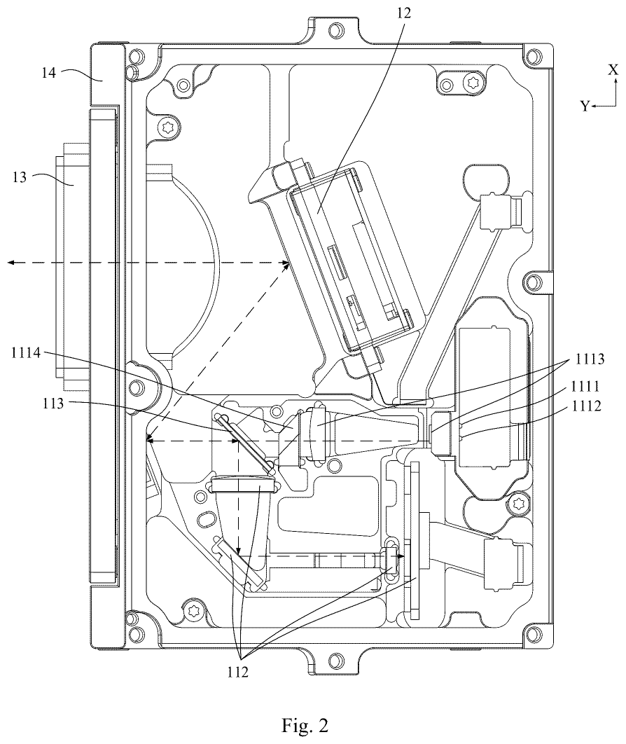

In some embodiments, as shown in FIG. 2, the transceiver module 11 includes an emitting component 111, a receiving component 112, and a beam splitting component 113. The emitting component 111 is used to generate an outgoing light and emit it to the beam splitting component 113; the beam splitting component 113 allows the outgoing light from the transmitting component 111 to pass through and emit to the scanning module 12, and allows the echo light from the scanning module 12 to emit to the receiving component 112, so that the transmitting light path and the receiving light path are separated from each other in the transceiver module 11; the receiving component 112 is used to receive the echo light from the beam splitting component. The emitting component 111 includes an emitter and an emitting mirror group 1113; the emitter is used to emit the outgoing light, a quantity of emitters can be one, multiple or an emitting array, and the emitter can be a laser diode, such as an edge-emitting laser, a vertical cavity surface laser emitter, etc.; the emitting mirror group 1113 includes a collimating mirror group, such as a fast-axis collimating mirror and a slow-axis collimating mirror, which are used to collimate the outgoing light emitted by the emitter. The receiving component 112 includes a receiver and a receiving mirror group; the receiver is used to receive the echo light and perform photoelectric conversion, and the receiver can be a photodiode, an avalanche diode, a silicon photomultiplier tube, etc. The beam splitting component can be an aperture reflector, a polarization beam splitter plate, a polarization beam splitter prism, etc.

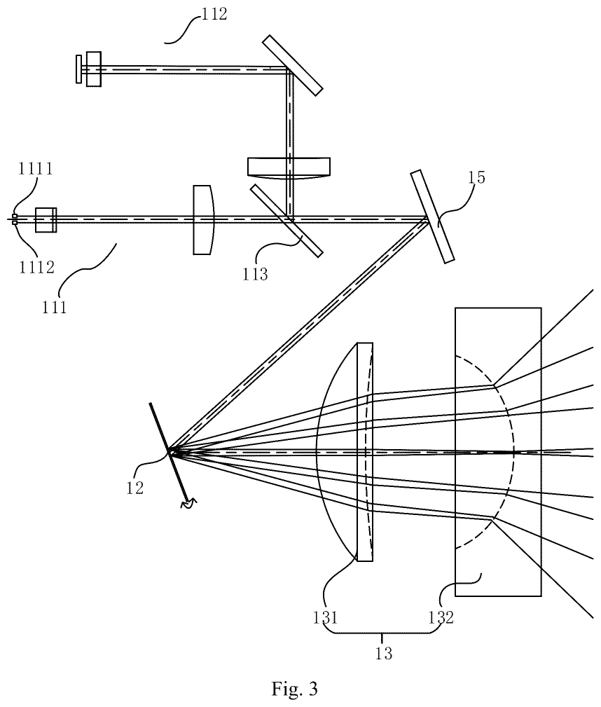

In some embodiments, as shown in FIG. 3, the beam adjustment module 13 includes a first lens 131 and a second lens 132 that are spaced apart, the first lens 131 being disposed between the transceiver module 11 and the second lens 132, and the second lens 132 being disposed between the first lens 131 and the scanning module 12. The first lens 131 is configured to converge the outgoing light, and the second lens 132 is configured to diffuse the outgoing light, thereby increasing the outgoing angle of the outgoing light and expanding the field of view.

In some embodiments, as shown in FIG. 3, different regions of the beam adjustment module 13 have different magnifications for the outgoing light. The beam adjustment module 13 is used to magnify the outgoing angles of multiple beams according to the incident angles of the beams, and the magnification of the outgoing angles of the beams is a monotonically increasing function of the incident angles of the beams. The incident angle of the beam is an angle between the light emitted from the scanning module 12 to the beam adjustment module 13 and the surface normal of the beam adjustment module 13, when the light intersects with the surface of the beam adjustment module 13. The magnification factor can be used to characterize the magnification factor of the outgoing angle of the beam, and the outgoing angle of the beam is the angle between the transmission direction axis of the beam and the central axis of the beam adjustment module 13. The magnification factor of the outgoing angle of the beam is a monotonically increasing function of the incident angle of the beam, that is, the larger the incident angle of the beam, the greater the magnification factor of the beam by the beam adjustment module 13; the smaller the incident angle of the beam, the smaller the magnification factor of the beam by the beam adjustment module 13. The magnification factor of the light beam adjustment module on the outgoing angle of the light beam is gradually changed, and changes with the change of the incident angle.

When the beam adjustment module is applied in the LiDAR, the magnification factor of the output angle of the outgoing light with a smaller incident angle is small, that is, the magnification factor of the output angle of the outgoing light at the center field angle is small; the magnification factor of the output angle of the outgoing light with a larger incident angle is large, that is, the magnification factor of the output angle of the outgoing light at the edge field angle is large. In this way, when the angles between the outgoing lights directed to the beam adjustment module after the scanning module is deflected and scanned are the same, after passing through the beam adjustment module, the magnification factor of the output angle of the outgoing light in the center region of the field of view is small, and the magnification factor of the output angle of the outgoing light in the edge region of the field of view is large, forming an expanded field of view. Meanwhile, the detection coefficient of the dense center region of the field of view and the edge region of the field of view gradually increases from the middle region to the edge region, and the transition is monotonous.

When the scanning module 12 uses a two-dimensional galvanometer, its fast axis direction uses resonant motion, the deflection motion speed of the end position is slow, and the deflection motion speed of the middle position is fast. The laser emission frequency corresponding to the end position is large, and the laser emission frequency corresponding to the middle position is small. The laser is emitted at a periodic frequency change, and the emission frequency of each emission cycle changes according to the law of large-small-large, so that the angle between the emitted light emitted to the beam adjustment module 13 after the two-dimensional galvanometer deflection scanning is the same, that is, the angle between the emitted light after the two-dimensional galvanometer deflection is the same as the adjacent last/next emission light beam. On the basis of the variation law of the emission frequency of each emission cycle, the emission frequency of the laser corresponding to the end position is further increased, and the emission frequency of the laser corresponding to the middle position is reduced. The angles between the emitted lights passing through the scanning module are different, and the angles between the emitted lights in the center region are greater than the angles between the emitted lights in the edge region. In this way, after passing through the beam adjustment module, the emitted light is emitted to the measured region at uniform angle intervals, and the detection range of a large field angle can be uniformly detected.

In some embodiments, the scanning module 12 is a galvanometer, a rotating mirror, or a combination thereof. A deflection angle of the outgoing light by the scanning module is limited, and a field of view formed by the outgoing light after the deflection scanning of the scanning module is limited. It is often necessary to stack the quantity of transceiver components to perform field of view splicing, to obtain a larger field of view. The LiDAR provided in embodiments adopts a combination of a scanning module and a beam adjustment module. The outgoing laser passing through the scanning module further expands the exit angle through the beam adjustment module, and only a small quantity of transceiver components needed to achieve detection of a large field of view.

In some embodiments, as shown in FIGS. 1 and 2, the LiDAR 1 includes a transceiver module 11, a scanning module 12 and a beam adjustment module 13. The outgoing light of a transceiver module is directed to the scanning module 12, and after being deflected and scanned by the scanning module 12, the outgoing light covers a first angle θ1; the outgoing light can be directed to the beam adjustment module 13. The beam adjustment module 13 is configured to increase the outgoing angle of the outgoing light, so that the outgoing light increases from the first angle θ1 to the second angle θ2 and is directed to the measured region; the first angle θ1 is smaller than the second angle θ2. Using a transceiver module to form a large field of view angle detection with a second angle θ2 simplifies system design, reduces apparatus consumption and assembly manpower.

As shown in FIG. 1, the LiDAR 1 further includes a mounting surface 141, on which the transceiver module 11, the scanning module 12 and the beam adjustment module 13 are all arranged. The transceiver module and the scanning module 12 are arranged along a first direction, and the scanning module 12 and the beam adjustment module 13 are arranged along a second direction.

In some embodiments, the LiDAR 1 includes a housing 14, the bottom surface of the housing 14 is the mounting surface 141 and the transceiver module 11, the scanning module 12 and the beam adjustment module 13 are arranged in the space inside the housing 14 and fixedly arranged on the bottom surface. The transceiver module 11, the scanning module 12 and the beam adjustment module 13 are fixed on the bottom surface and are approximately in the same plane. The optical paths connecting the modules are transmitted along a plane parallel to the mounting surface 141, and there is no need to stack the components in the height direction, which can effectively control the height of the components inside the LiDAR, thereby compressing the height size of the LiDAR and facilitating the flexible installation of the LiDAR in the application scenario.

The transceiver module 11 and the scanning module 12 are arranged along the first direction, and the scanning module 12 and the beam adjustment module 13 are arranged along the second direction; through this arrangement, the multiple modules in the LiDAR can be compactly placed in the shell, the volume can be controlled, and the light path connecting the modules is prevented from being blocked. The outgoing light after deflection by the scanning module 12 faces the beam adjustment module 13, and the outgoing angle of the first angle θ1 formed by the scanning module 12 scanning the deflected outgoing light is symmetrically arranged relative to the central axis of the beam adjustment module 13, and the outgoing light whose outgoing angle is expanded by the beam adjustment module 13 is also symmetrically arranged relative to the central axis of the beam adjustment module 13; the center of the LiDAR field of view angle faces the measured region, which has a good detection effect, effectively detects the region directly in front of the LiDAR in the application scenario, and is convenient for the design of the installation structure.

As shown in FIG. 2, the transceiver module 11 includes an emitting component 111, a receiving component 112 and a light splitting component; the emitting component 111 is configured to emit outgoing light, the receiving component 112 is configured to receive echo light, and the light splitting component is configured to separate the optical paths of the outgoing light and the echo light; wherein the emitting component 111 and the receiving component 112 are both disposed on the mounting surface 141, and arranged along the first direction.

In some embodiments, the transceiver module 11 includes an emitting component 111 and a receiving component 112, and the emitting component 111 and the receiving component 112 are both fixed to the mounting surface 141 and arranged along the first direction. This arrangement can compress the height of the transceiver module, thereby compressing the thickness of the shell and reducing the volume of the LiDAR. This arrangement can form the mounting structure of the transceiver module and the shell into one piece, and there is enough space above the mounting structure for assembling and adjusting the optical lens, reducing assembly materials and simplifying the optical adjustment steps.

In some embodiments, the structures for installing the transceiver module 11, the scanning module 12 and the beam adjustment module 13 are integrally formed with the housing 14, thereby reducing the quantity of assembly materials and simplifying the assembly steps between the transceiver module, to improve the assembly efficiency of the LiDAR; and the important optical modules, the transceiver module, the scanning module and the beam adjustment module are installed on the same housing, with high assembly precision, and the matching precision between the important optical modules is high, so that the LiDAR can have high detection precision and accuracy; the light adjustment required for assembling the important optical modules with the housing is eliminated, simplifying the assembly steps.

As shown in FIGS. 2, 3 and 5, the emitting component 111 includes a first emitter 1111, a second emitter 1112 and an emitting mirror group 1113. The first emitter 1111 and the second emitter 1112 are staggered in the first direction and the third direction, and are symmetrical along the central axis of the emitting mirror group 1113; wherein the third direction is perpendicular to the first direction and the second direction.

The emission component 111 includes a plurality of emitters, which may include at least a first emitter 1111 and a second emitter 1112. The first emitter 1111 emits a first outgoing light 1115, and the second emitter 1112 emits a second outgoing light 1116. The emission lens group 1113 is used to collimate the first outgoing light 1115 and the second outgoing light 1116. The first emitter 1111 and the second emitter 1112 are staggered in the first direction and the third direction, and are symmetrical along the central axis of the emission lens group 1113. Facing the emission lens group 1113 along the central axis, the first emitter 1111 is arranged at the upper left of the central axis, and the second emitter 1112 is arranged at the lower right of the central axis. A distance between the first emitter 1111 and the central axis along the first direction is x0, and a distance between the second emitter 1112 and the central axis along the first direction is also x0; similarly, a distance between the first emitter 1111 and the central axis along the third direction is z0, and a distance between the second emitter 1112 and the central axis along the second direction is also z0.

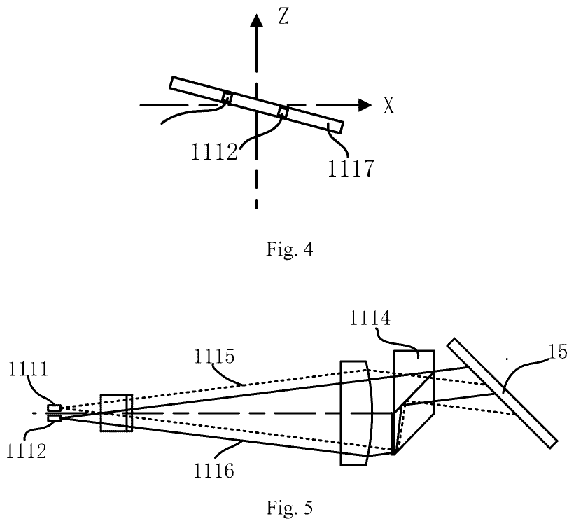

As shown in FIG. 5, taking the first direction as an example, the two outgoing light beams emitted by the first emitter 1111 and the second emitter 1112 are not on the central axis of the emission mirror group 1113. The emission mirror group 1113 is configured to collimate the first outgoing light 1115 and the second outgoing light 1116. After collimation, the light beams are not transmitted parallel to the central axis. The first outgoing light 1115 and the second outgoing light 1116 are deflected toward the central axis after collimation, and the deflection angles are the same. As shown in FIG. 4, an angle between the first outgoing light 1115 and the central axis after collimation is a, and an angle between the second outgoing light 1116 and the central axis after collimation is also a, so that there is an angle of 2α between the two light beams. After the first outgoing light 1115 and the second outgoing light 1116 pass through the beam splitter 113 and the scanning module 12, since these devices have the same effect on the two light beams and only adjust the propagation direction of the light beams, the angle of 2α between the two light beams is still maintained. After the first outgoing light 1115 and the second outgoing light 1116 are deflected and scanned by the scanning module, they are directed toward the light adjustment module; after the two light beams pass through the light adjustment module to increase the outgoing angle, the included angle becomes larger, that is, the included angle between the first outgoing light 1115 and the second outgoing light 1116 directed toward the measured region by the LiDAR 1 is greater than 2α. The transmission direction characteristics of the first outgoing light 1115 and the second outgoing light 1116 in the third direction are similar to those in the first direction, and will not be repeated here.

The quantity of lasers is increased, and the emitted light of multiple lasers is staggered in the first direction and the third direction. After passing through the scanning module and the beam adjustment module, the multiple emitted light emitted to the measured region is also staggered, which can improve the detection resolution in the first direction and the third direction, and improve the problem that the emitted light is far apart and the detection resolution is insufficient due to the beam adjustment module increasing the emission angle of the emitted light.

The arrangement positions of the first emitter and the second emitter are symmetrical with respect to the central axis of the transmitting mirror group, so that the first emitted light and the second emitted light are at a certain angle during the transmission process, and the angle is symmetrical with respect to the central axis of the emission light path. After the first emitted light and the second emitted light pass through the light adjustment module, the angle between the two light beams can be further increased. After the first emitted light and the second emitted light pass through the light adjustment module to increase the emission angle, they are also symmetrical with respect to the central axis of the light path, forming a regular field of view and a symmetrical resolution distribution, which is convenient for the application and installation of the LiDAR. The two light beams are staggered at a certain distance in the measured region, and the second emitted light is located between two adjacent first emitted lights, effectively improving the detection resolution.

In some embodiments, as shown in FIGS. 2 and 4, the first emitter 1111 and the second emitter 1112 are disposed on an emitting plate 1117, and the emitting plate 1117 is disposed perpendicular to the second direction and rotated around the second direction by a first angle. The first emitter 1111 and the second emitter 1112, as well as the driving control circuits of the first emitter 1111 and the second emitter 1112 are disposed on an emitting plate 1117. The first emitter 1111 and the second emitter 1112 are fixed on the same emitting plate 1117 through a connection process, so that the distance accuracy between the two emitters can be easily ensured. The emitting plate 1117 is disposed parallel to the second direction, and the first emitter 1111 and the second emitter 1112 are fixed to the side edge of the emitting plate 1117, and emit the first outgoing light 1115 and the second outgoing light 1116 to align with the emission mirror group 1113. The emitting plate 1117 can be arranged parallel to a plane formed by the first direction and the second direction, or can be arranged parallel to a plane formed by the second direction and the third direction. The emitting plate 1117 rotates a first angle around the second direction, so that the first emitter 1111 and the second emitter 1112 can be staggered in both the first direction and the third direction. The value range of the first angle is −2° to 2°. By setting multiple emitters on the same emitting plate and rotating the emitting plate to tilt it, the quantity of emitting plates can be reduced and the distance accuracy between adjacent transmitters can be ensured. In addition, the emitting component can be assembled first, the emitting component can be clamped and placed in the installation position, and the rotating optical adjustment can be performed. After the optical adjustment is completed, it can be fixed, which simplifies the assembly and optical adjustment process. There is no need to adjust the optical adjustment of multiple lasers separately and then fix them, and the positional relationship between adjacent lasers will not be affected by adjusting a certain laser.

As shown in FIG. 5, the emitting component 111 further includes a beam reducing mirror group 1114, which is configured to reduce a cross-sectional size of the emitted light. The first emitted light 1115 emitted by the first emitter 1111 is emitted to the beam reducing mirror group 1114 at a first incident angle, and the second emitted light 1116 emitted by the second emitter is emitted to the beam reducing mirror group 1114 at a second incident angle, and the first incident angle and the second incident angle are opposite to each other. The beam reducing mirror group is arranged in the emission direction of the transmitting mirror group, and is used to compress the spot size of the emitted light after collimation by the transmitting mirror group, increase the energy density of the emitted light, and enhance the ranging capability of the LiDAR.

In some embodiments, the first output light 1115 is emitted to the beam reduction mirror group 1114 at a first incident angle, and the second output light 1116 is emitted to the beam reduction mirror group 1114 at a second incident angle, and the first incident angle and the second incident angle are opposite to each other. The incident surface of the beam reduction mirror group 1114 is arranged perpendicular to the central axis of the emission mirror group 1113. The first emitter 1111 and the second emitter 1112 are distributed on both sides of the central axis and are symmetrical. After being collimated by the emission mirror group 1113, there is an angle between the first output light 1115 and the second output light 1116, such as the aforementioned angle 2α. The first outgoing light 1115 and the second outgoing light 1116 enter the beam reduction mirror group 1114 at incident angles opposite to each other. The incident surface of the beam reduction mirror group 1114 is perpendicular to the central axis of the transmitting mirror group 1113. After being processed by the beam reduction mirror group 1114, the first outgoing light 1115 and the second outgoing light 1116 can still maintain the same angle (such as angle 2α) as when they were incident, and the angles between the first outgoing light 1115 and the second outgoing light 1116 and the central axis are still the same, such as angle α. Through such a setting, the beam reduction mirror group can compress the cross-sectional dimensions of the first outgoing light 1115 and the second outgoing light 1116, but does not change the angle between the two light beams and the angles between the two light beams and the central axis of the optical path, thereby simplifying the design and assembly requirements of the rear-end beam adjustment module.

The beam reduction mirror group 1114 includes a separation surface and a reflection region and a beam combining region disposed on both sides of the separation surface. The central axis of the first output light 1115 directed to the beam reduction mirror group 1114 is spaced apart from the separation surface by a first distance along the first direction, and the central axis of the second output light 1116 is spaced apart from the separation surface by a second distance along the first direction, and the first distance is equal to the second distance. The separation surface of the beam reduction mirror group 1114 is arranged along the central axis of the emission mirror group 1113 (the central axis of the optical path). The collimated first output light 1115 and the second output light 1116 are directed toward the beam reduction mirror group 1114. Since the distance between the beam reduction mirror group 1114 and the emission mirror group 1113 is relatively close, even if the first output light 1115 and the second output light 1116 collimated by the emission mirror group 1113 form an angle, the two light beams still largely overlap, as shown in FIG. 4. When the first output light 1115 and the second output light 1116 reach the incident surface of the beam reduction mirror group 1114, the central axis of the first output light 1115 is spaced apart from the dividing surface by a first distance along the first direction, and the central axis of the second output light 1116 is spaced apart from the dividing surface by a second distance along the first direction, that is, the first output light 1115 and the second output light 1116 are symmetrically distributed relative to the central axis of the optical path, and are also symmetrically distributed relative to the dividing surface of the focusing mirror assembly 1114. As shown in FIG. 4, when the second output light 1116 is emitted to the beam reducing mirror group 1114, the angle between the second output light 1116 and the central axis of the optical path is positive, and the second output light 1116 emitted to the beam combining region still maintains the transmission direction. After the second output light 1116 emitted to the reflection region is reflected and combined, the second output light 1116 still maintains the transmission direction. After the second output light 1116 passes through the beam reducing mirror group 1114, a cross-sectional size of the light beam is reduced by half, but the transmission direction of the light beam remains unchanged. Similarly, after the first output light 1115 is emitted to the beam reducing mirror group 1114, the transmission direction remains unchanged. The beam reducing mirror group can compress the cross-sectional size of both the first output light 1115 and the second output light 1116, but does not change the angle between the two light beams and the angle between the two light beams and the central axis of the optical path.

The second emitted light 1116 directed toward the reflection region and the normal of the reflection surface of the reflection region is greater than the angle between the light beam of the first emitted light 1115 directed toward the reflection region and the normal of the reflection surface of the reflection region. The light beam at the edge of the second emitted light 1116 after being reflected by the reflection region and the beam combining region is located outside the light beam at the edge of the first emitted light 1115 after being reflected by the reflection region and the beam combining region. The positions of the first emitted light 1115 and the second emitted light 1116 after passing through the beam reduction module are changed compared to the central axis of the optical path. As shown in FIG. 4, when the first emitted light 1115 enters the beam reduction lens group 1114, the central axis of the first emitted light 1115 is located above the central axis of the optical path; after the first emitted light 1115 passes through the beam reduction lens group 1114, the central axis of the first emitted light 1115 is located below the central axis of the optical path. The same is true for the second emitted light 1116. The first outgoing light 1115 and the second outgoing light 1116 maintain such a positional relationship with the central axis of the optical path, until the first echo light and the second echo light returning coaxially are received respectively. The first outgoing light and the second outgoing light are symmetrical with respect to the central axis of the optical path and are sequentially emitted to the scanning module and the beam adjustment module, simplifying the design of the beam adjustment module, and a regular field of view and a symmetrical resolution distribution can be obtained through a symmetrical optical design.

As shown in FIGS. 3 and 5, the LiDAR 1 further includes a reflex component 15, which is configured to deflect the outgoing light from the transceiver module 11 to the scanning module 12, and also deflects the echo light from the scanning module 12 to the transceiver module 11. The reflex component enables the optical path between the transceiver module and the scanning module to be reflexed and adjusted in direction through the reflex component, and the transceiver module and the scanning module can be arranged in a first direction in the housing to make the internal structure compact, thereby reducing the volume of the LiDAR.

In some embodiments, the reflex component 15 is disposed on the mounting surface 141, and the reflex component 15 and the transceiver module 11 are disposed along the second direction. By arranging the centers of the transceiver module, the reflex component, the scanning module, and the beam adjustment module on the same plane perpendicular to the third direction (e.g. the height direction), the optical path between the optical modules is also transmitted along the plane, so that the components and optical paths inside the LiDAR I are distributed along the same height plane, reducing the stacking along the third direction, compressing the size occupied in the height direction, and reducing the size of the housing.

In some embodiments, the reflex component 15 may include devices such as a reflector, a polarization beam splitter, and a refractor that can change the transmission direction of light, and the reflex component 15 and the beam adjustment module 13 are arranged side by side along the first direction. When the reflector of the reflex component 15 is installed, it can extend from the outside of the shell into the inside of the shell, and clamp the reflector from the rear side of the reflector, and fix it after the reflector light adjustment is completed, so as to facilitate the assembly of the light adjustment. The shell 14 includes a front mounting plate extending in the first direction, and the reflex component 15 and the beam adjustment module 13 are both arranged on the front mounting plate. The reflex component is located upstream of the optical path, and the beam adjustment module is installed after the reflex component is assembled and the light adjustment is completed, so as to improve the assembly efficiency and light adjustment accuracy, and improve the detection accuracy and precision of the LiDAR.

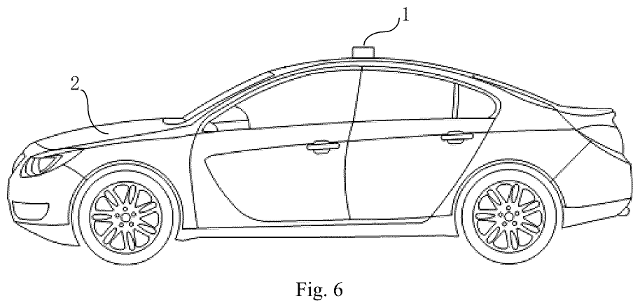

Embodiments of the present application also provides an automatic driving apparatus, as shown in FIG. 6, which includes an apparatus body 2 and a LiDAR 1 installed on the apparatus body 2. The structure of the LiDAR 1 refers to the above embodiment. Since the automatic driving apparatus adopts all the technical solutions of the LiDAR 1 of all the above embodiments, it has at least all the beneficial effects brought by the technical solutions of the LiDAR 1 of the above embodiments, which will not be described one by one here. The automatic driving apparatus can be a car, a ship, an aircraft, etc.

What is claimed is:

1. A LIDAR, comprising:
a transceiver module, a scanning module and a beam adjustment module; wherein
the transceiver module is configured to emit an outgoing light according to a preset timing, and emit the outgoing light toward the scanning module;
the scanning module is configured to deflect the outgoing light toward the beam adjustment module;
the beam adjustment module is configured to increases an outgoing angle of the outgoing light, and the outgoing light is emitted toward a measured region at uniform angle intervals;
the beam adjustment module is further configured to receive an echo light, and direct the echo light toward the scanning module;
the scanning module is further configured to deflect the echo light toward the transceiver module; the transceiver module is configured to receive the echo light;
wherein the echo light is a beam of light returned after the outgoing light is reflected by a measured object in the measured region.

2. The LiDAR according to claim 1, further comprising a mounting surface, wherein the transceiver module, the scanning module and the beam adjustment module are arranged on the mounting surface, the transceiver module and the scanning module are arranged along a first direction, and the scanning module and the beam adjustment module are arranged along a second direction.

3. The LiDAR according to claim 2, wherein the transceiver module comprises an emitting component, a receiving component and a light splitting component;
wherein the emitting component is configured to emit the outgoing light, the receiving component is configured to receive the echo light, and the light splitting component is configured to separate the optical paths of the outgoing light and the echo light; and
wherein the emitting component and the receiving component are disposed on the mounting surface and arranged along the first direction.

4. The LiDAR according to claim 3, wherein the emitting component comprises a first emitter, a second emitter and an emitting mirror group, the first emitter and the second emitter are staggered in the first direction and the third direction, and are symmetrical along the central axis of the emitting mirror group, and the third direction is perpendicular to the first direction and the second direction.

5. The LiDAR according to claim 4, wherein the first emitter and the second emitter are arranged on an emitting plate, the emitting plate is arranged parallel to the second direction and rotated around the second direction by a first angle.

6. The LiDAR according to claim 4, wherein the emitting component comprises a beam reducing mirror group,
wherein the beam reducing mirror group is configured to reduce a cross-sectional size of the emitted light, a first output light emitted by the first emitter is emitted to the beam reducing mirror group at a first incident angle, and a second output light emitted by the second emitter is emitted to the beam reducing mirror group at a second incident angle, and the first incident angle and the second incident angle are opposite to each other.

7. The LiDAR according to claim 6, wherein the beam reducing mirror group comprises a dividing surface, a reflection region and a beam combining region,
wherein the reflection region and the beam combining region are arranged on sides of the dividing surface, the central axis of the first output light emitted to the beam reducing mirror group is spaced apart from the dividing surface by a first distance along the first direction, the central axis of the second output light is spaced apart from the dividing surface by a second distance along the first direction, and the first distance is equal to the second distance.

8. The LiDAR according to claim 2, further comprising a reflex component, wherein the reflex component is configured to deflect the outgoing light from the transceiver module to the scanning module, and deflect the echo light from the scanning module to the transceiver module.

9. The LiDAR according to claim 8, wherein the reflex component is arranged on the mounting surface, and the reflex component and the transceiver module are arranged along the second direction.

10. An automatic driving apparatus, comprising:
an apparatus body; and
the LiDAR according to claim 1 installed on the apparatus body.
